(19) United States
(12) Patent Application Publication
(10) Pub. No.: US 2011/0075660 A1
(43) Pub. Date: Mar. 31, 2011

(54) DYNAMIC NETWORK SELECTION

(75) Inventors: Dieter Jacobsohn, Bonn (DE); Karl-Heinz Nenner, Bornheim (DE)

(73) Assignee: T-Mobile International AG, Bonn (DE)

(21) Appl. No.: 12/675,071

(22) PCT Filed: Aug. 24, 2007
(86) PCT No.: PCT/EP2007/007465

§ 371 Date: Feb. 24, 2010

(51) Int. Cl. H04L 12/50

(52) U.S. Cl. 370/357

(57) ABSTRACT

The invention relates to a telecommunication system featuring partly CS-based telecommunication and partly PS-based telecommunication. A dynamic controller is provided for making allocations between the parts, taking into account access network requests. A corresponding method and a computer program for implementing the controller are also claimed.

The invention relates to a telecommunication network and a method for controlling the allocation of a telecommunication user equipment to a terminal network.

Telecommunication is currently undergoing a revolution. It is an improvement, for instance, that the handover from conventional CS-based telecommunication (CS=circuit switching) to Internet-based PS telecommunication (PS=packet switching) is applied increasingly more frequently.

This improvement, however, requires that a certain cooperation (interworking) must take place between these systems as long as these different systems are used in parallel with each other.

Such an interworking appears necessary in particular for all services that contain voice.

Such an interworking between these systems is required because
voice in the PSTN/ISDN is predominantly CS-based;
voice on the Internet is predominantly PS-based;
most current cellular mobile radio systems support CS voice;
future generation cellular mobile radio systems no longer support CS services, since all voice services will be based on VoIP (Voice over Internet Protocol).

This interworking is normally carried out by means of an interworking server, which implements a one-to-one transcoding of the voice signals where necessary.

The problem that arises in this context is when and how it is decided and controlled within a network whether voice is implemented via the conventional CS service or via VoIP. In the known solutions this is done using predefined static scenarios.

The object of the present invention can therefore be considered that of avoiding or circumventing this fixed allocation of the type of voice signal.

This object is achieved according to the invention by the technical teaching of the independent claims.

Advantageous embodiments and improvements of the invention will become apparent from the dependent claims, the content of which is hereby referenced.

More particularly, the inventive dynamic allocation control allows various criteria to be taken into account.

The following criteria are taken into account, with the following list not being intended to limit the scope of the invention. On the contrary, all other known possible criteria for taking into account such criteria for a dynamic access control are claimed also.

For outgoing calls the following criteria can be taken into account:
service
destination network
subscriber preferences
network operator preferences

For incoming calls the following criteria can be taken into account:
service
originating network
subscriber preferences
network operator preferences

A further embodiment of the invention provides for introducing an additional information exchange between the existing radio infrastructure and the selected domain.

Through this information exchange operator-specific radio parameters and user equipment properties can be integrated into the decision process. Consequently, this results in new criteria for the allocation.

The question of when and how a decision is made within a network with respect to controlling voice can be answered such that that the access network control is carried out under incorporation of operator-specific radio parameters and user equipment properties, the objective being that of deciding and controlling whether voice is implemented via the conventional CS service or via VoIP.

For outgoing calls the resulting criteria are as follows:
service
destination network
static and dynamic user equipment properties for subscribers A and B
subscriber preferences
network operator preferences

For mobile incoming calls the resulting criteria are as follows:
service
originating network
static and dynamic user equipment properties for subscribers A and B
subscriber preferences
network operator preferences

The invention will be described in more detail below in conjunction with drawings that illustrate one possible embodiment. Additional features that are essential to the invention and advantages of the invention will become apparent from the drawings and their description.

In the drawings,

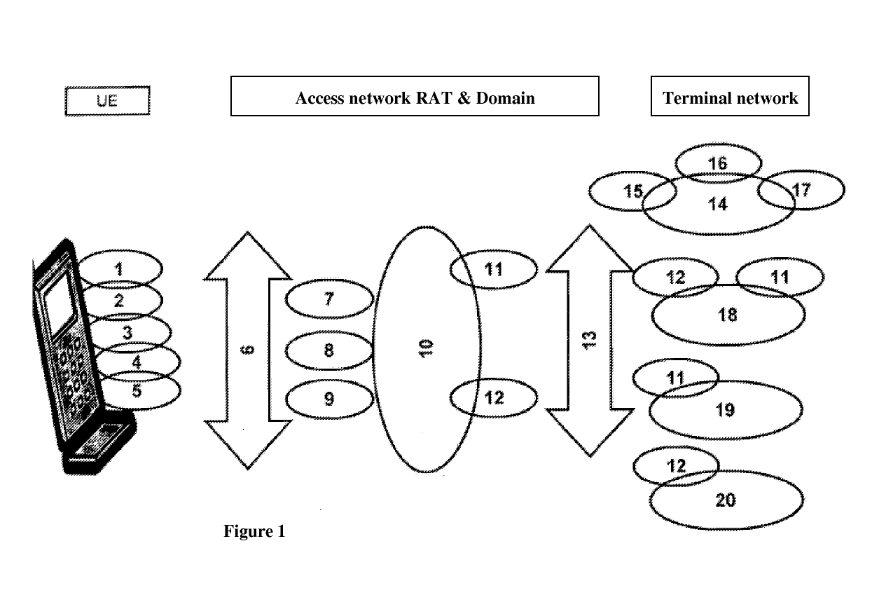

FIG. 1 shows an access control according to the prior art;

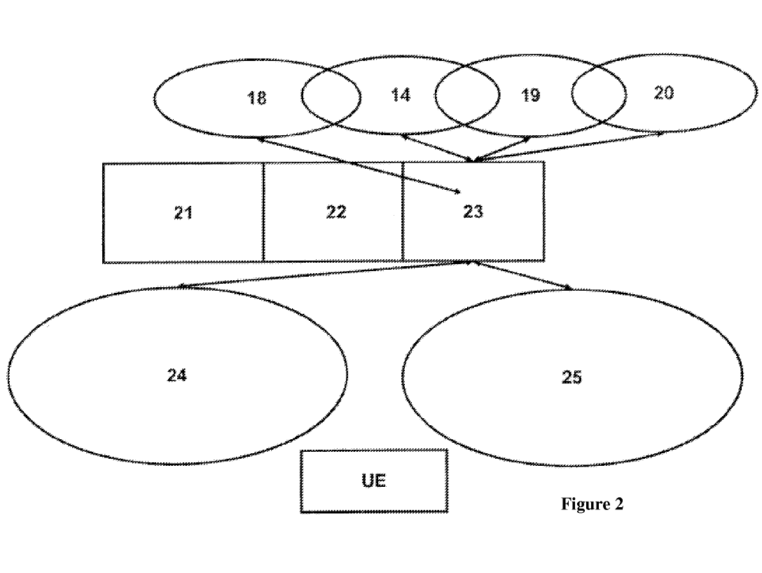

FIG. 2 shows an inventive dynamic access control.

The access control depicted in FIG. 1 shows a handoff from a circuit-switching (CS) telecommunication to a packet-switching (PS) telecommunication, which is known, for example, from telecommunication on the Internet.

Such a packet-switched communication is carried out by means of various protocols, such as for example 2G or 3G, in which it is necessary for a handoff from CS communication to PS communication that the two communication systems are capable of cooperating with one another.

This cooperation for the handoff between these systems is known from the prior art as so-called interworking, which is carried out by means of an interworking server.

From a mobile user equipment (UE) voice signals are transmitted circuit-switched (1, 2) or packet-switched (3, 4, 5) to an interworking server in the particular access network (10).

This server recognizes from the incoming voice signals whether the voice signals are circuit-switched (1, 2) or packet-switched (3, 4, 5).

After the appropriate transcoding in the access network (10) these voice signals are relayed to the appropriate network either circuit-switched CS (11) or packet-switched PS (12).

It is possible to relay such voice signals to a service portal (14) comprising a virtual network VPN (15), an intelligent network IN (16), or an IP multimedia subsystem IMS (17).

Additionally, the voice signals can be relayed as circuit-switched CS (11) or packet switched PS (12) voice signals to a mobile radio network PLMN (18).

Additionally, the voice signals can be relayed as circuit-switched CS (11) signals to a public switched telephone network PSTN (19) or as packet switched PS (12) signals to the Internet (20).

The inventive solution for controlling voice signals that is shown in FIG. 2 illustrates that voice signals are relayed by means of a corresponding controller (23) from a CS access network (24) or from a PS access network (25) directly to the Internet (20), to the public switched telephone network (19), to a service portal (14), or to a mobile radio network (18), with the controller (23) dynamically making the decision to relay the voice signals to the respective network by means of the aforementioned decision criteria.

It is important in this context that the respective voice signals are transmitted to the controller (23) via an access network (24) with circuit switched CS voice signals or from an access network (25) with packet-oriented PS voice signals.

The subject matter of the present invention is attained not only from the subject of the individual claims but also from the combination of the individual claims with one another.

All of the specifications and features disclosed herein, including in the abstract, especially the three-dimensional embodiment depicted in the drawings, are claimed as essential to the invention to the extent that they are novel either individually or in combination over the prior art.

### LIST OF REFERENCE NUMERALS

1. 2G CS (CS=2nd generation circuit switching)
2. 3G CS (CS=3rd generation circuit switching)
3. 2G PS (PS=2nd generation packet switching)
4. 3G PS (PS=3rd generation packet switching)
6. Selection
7. 2G (2^{nd} generation)
8. 3G (3^{rd} generation)
9. LTE (Long Term Evolution (working term for the radio portion of the next generation mobile networks)
10. Access network
11. CS (CS=circuit switching)
12. PS (PS=packet switching)
13. Selection
14. Service portal
15. VPN (virtual private network)
16. IN (intelligent network)
17. IMS (IP multimedia subsystem)
18. PLMN (public land mobile network)
19. PSTN (public switched telephone network)
   ISDN (integrated services digital network)
20. Internet
21. Control data base
22. Control logic
23. Controller
24. CS access network
25. PS access network

1. A telecommunication system comprising at least one subsystem with CS-based telecommunication and at least one other subsystem with PS-based VoIP telecommunication, wherein a controller (23) is provided that implements a dynamic allocation between at least one subsystem with CS-based telecommunication and at least one subsystem with PS-based telecommunication, wherein access network requests are taken into account at least partially, wherein an additional exchange of information implements an integration of operator-specific parameters and user equipment properties into a decision process for the dynamic allocation.

2. A method for allocating at least a portion of a voice connection of a telecommunication system to CS-based or PS-based (segments of) transmission paths, wherein this allocation takes place dynamically based on requirements of the access network (24, 25).

3. A method according to claim 2, wherein the control (23) of the allocation is carried out in a context-based manner.

4. A method according to claim 2, wherein an additional information exchange between the existing radio infrastructure and the selected domain via CS or PS is performed in the control (23) of the allocation.

5. A computer program stored on a non-transitory computer readable medium, having a program code with the aid of which all steps of allocating at least a portion of a voice connection of a telecommunication system to CS-based or PS-based (segments of) transmission paths according to a method according to claim 2 can be carried out, wherein the computer program is executed on a computer or appropriate computer unit, wherein a dynamic allocation is implemented based on requirements of the access network (24, 25).

6. A computer program product having a program code stored on a computer-readable non-transitory data carrier, with the aid of which all steps of allocating at least a portion of a voice connection of a telecommunication system to CS-based or PS-based (segments of) transmission paths according to a method according to claim 2 can be carried out, wherein the computer program is executed on a computer or appropriate computer unit, wherein a dynamic allocation is implemented based on requirements of the access network (24, 25).
